(19) United States
(12) Patent Application Publication
(10) Pub. No.: US 2004/0186015 A1
(43) Pub. Date: Sep. 23, 2004

(54) Catalyst for use in producing lower aliphatic carboxylic acid ester, process for producing the catalyst, and process for producing lower aliphatic carboxylic acid ester using the catalyst

(75) Inventors: Etsuko Kadowaki, Oita-shi (JP); Kousuke Narumi, Oita-shi (JP); Hiroshi Uchida, Oita-shi (JP)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: SHOWA DENKO K.K.

(21) Appl. No.: 10/813,167

(22) Filed: Mar. 31, 2004

Related U.S. Application Data
(62) Division of application No. 09/958,271, filed on Oct. 9, 2001, now abandoned.
Application No. 09/958,271 is a 371 of international application No. PCT/JP01/07709, filed on Sep. 5, 2001.
(60) Provisional application No. 60/238,431, filed on Oct. 10, 2000.

(30) Foreign Application Priority Data
Sep. 7, 2000 (JP) 2000-271416

(51) Int. Cl. B01J 31/00; B01J 27/188; B01J 27/19

(52) U.S. Cl. 502/208; 502/209; 502/210; 502/211; 502/170; 502/172

(57) ABSTRACT

A process for producing a catalyst for use in producing a lower aliphatic carboxylic acid ester. The catalyst is used in reacting a lower olefin with a lower aliphatic carboxylic acid in a gas phase to produce a lower aliphatic carboxylic acid ester. The process comprises the following first and second steps. The first step is a step of loading one or more heteropolyacid on a support to obtain a heteropolyacid supported catalyst. The second step is a step of contacting the heteropolyacid supported catalyst obtained in the first step with a gas containing at least one member selected from the group consisting of water, a lower aliphatic carboxylic acid and a lower aliphatic alcohol to obtain a catalyst for use in producing a lower aliphatic carboxylic acid ester.

### CROSS-REFERENCE TO RELATED APPLICATION

This is a Divisional Application of pending prior application Ser. No. 09/958,271 filed Oct. 9, 2001 which was the National Stage of International Application No. PCT/JP01/07709, filed Sep. 15, 2001, which claims benefit pursuant to 35 U.S.C. §119(e)(1) of the filing date of the Provisional Application 60/238,431 filed Oct. 10, 2000, pursuant to 35 §111(b), the disclosures of all of which are incorporated herein by reference.

### TECHNICAL FIELD

The present invention relates to a catalyst for use in producing a lower aliphatic carboxylic acid ester from a lower olefin and a lower aliphatic carboxylic acid, a process for producing the catalyst, and a process for producing a lower aliphatic carboxylic acid ester using the catalyst.

More specifically, the present invention relates to a catalyst, containing a specific heteropolyacid, which is used in a process for producing a lower aliphatic carboxylic acid ester by esterifying a lower aliphatic carboxylic acid with a lower olefin, wherein the catalyst is contacted with a gas containing at least one member selected from the group consisting of water, a lower aliphatic carboxylic acid and a lower aliphatic alcohol before the reaction; a process for producing the catalyst; and a process for producing a lower aliphatic carboxylic acid ester using the catalyst.

### BACKGROUND ART

As is well known, a corresponding ester can be produced from a lower aliphatic carboxylic acid and an olefin. Also, a catalyst comprising a heteropolyacid and/or a heteropolyacid salt is known to act effectively in this reaction. Specific examples of such a catalyst include those described in Kogyo Kagaku Zasshi (Journal of Industrial Chemistry), Vol. 72, No. 9 (1969) and Japanese Unexamined Patent Publications No. 4-139148 (JP-A-4-139148), No. 5-65248 (JP-A-5-65248), No. 5-294894 (JP-A-5-294894) and No. 9-118647 (JP-A-9-118647).

Among these specific examples, Kogyo Kagaku Zasshi (Journal of Industrial Chemistry), Vol. 72, No. 9 (1969) discloses a method of synthesizing ethyl acetate from ethylene and acetic acid using a silica supported tungstosilicic acid or a silica supported tungstophosphoric acid as the catalyst. According to this method, it is stated that the initial activity is high but the activity greatly decreases and, within only 3 hours, the activity reduction ratio reaches 10%. The catalyst containing tungstosilicic acid, molybdophosphoric acid or tungstophosphoric acid disclosed in JP-A-9-118647 has a problem in that the selectivity of the objective product is low and the activity decreases when a reaction is performed for a long period of time, though the initial activity is high.

In order to solve these problems, the methods disclosed in JP-A-4-139148 and JP-A-5-65248 and in Japanese Unexamined Patent Publication No. 4-139149 (JP-A-4-139149) use a catalyst containing at least one salt selected from the group consisting of cesium salts, rubidium salts, thallium salts, ammonium salts and potassium salts of tungstophosphoric acid, tungstosilicic acid, molybdophosphoric acid and molybdosilicic acid, where high initial activity and relatively high space time yield can be obtained and the selectivity of the objective product can be improved. However, their use, on an industrial basis, still has a problem to be solved in that the activity decreases and the space time yield also falls with the progress of reaction.

In order to solve this problem, Japanese Unexamined Patent Publication No. 5-170698 (JP-A-5-170698) proposes a method of contacting the catalyst described above with water and an organic carboxylic acid or an organic carboxylic acid ester in a gas phase before performing the reaction. In the production process using a catalyst subjected to a pre-contacting treatment according to the above-described method, it is revealed that the catalyst exhibits high initial activity and the activity scarcely decreases as compared with conventional production processes using a catalyst which is not subjected to the contacting treatment.

On the other hand, JP-A-5-294894 discloses a catalyst obtained by loading at least one heteropolyacid selected from the group consisting of lithium, copper, magnesium and gallium salts of heteropolyacids on a support and it is revealed that although the method disclosed in JP-A-5-170698, of contacting a catalyst with water and an organic carboxylic acid or an organic carboxylic acid ester in a gas phase before performing the reaction, is not used, the catalyst can exhibit initial activity equal thereto or higher and can maintain the activity.

### DISCLOSURE OF INVENTION

The object of the present invention is to provide a catalyst, for use in producing a lower aliphatic carboxylic acid ester from a lower olefin and a lower aliphatic carboxylic acid, which exhibits high initial activity and high space time yield, ensures a catalyst life long enough to endure practice in industry and can reduce the production of by-products; a process for producing the catalyst; and a process for producing a lower aliphatic carboxylic acid ester using the catalyst.

The present inventors have made extensive investigations for a catalyst not only capable of exhibiting high initial activity and sufficiently long catalyst life but also reduced in the production of by-products during the reaction of a lower olefin with a lower aliphatic carboxylic acid in a gas phase to produce a lower aliphatic carboxylic acid ester. As a result, it has been found that although a neutralized salt of heteropolyacid is not used as the catalyst, when a specific step is provided in the preparation of the heteropolyacid catalyst, the reduction of activity can be prevented. The present invention has been accomplished based on this finding. Furthermore, in the practice of the present invention, it is revealed that the production of by-products harmful to the catalyst, such as butene and aldehyde, can be greatly reduced. The present invention has also been accomplished based on this finding.

More specifically, the present invention (I) is a catalyst, for use in producing a lower aliphatic carboxylic acid ester, which is used in reacting a lower olefin with a lower aliphatic carboxylic acid in a gas phase to produce a lower aliphatic carboxylic acid ester, wherein the process for producing the catalyst comprises the following first and second steps:

First Step

a step of loading one or more heteropolyacid on a support to obtain a heteropolyacid supported catalyst; and

Second Step

a step of contacting the heteropolyacid supported catalyst, obtained in the first step, with a gas containing at least one member selected from the group consisting of water, a lower aliphatic carboxylic acid and a lower aliphatic alcohol to obtain a catalyst for use in producing a lower aliphatic carboxylic acid ester.

The present invention (II) is a process for producing a catalyst, for use in producing a lower aliphatic carboxylic acid ester, the catalyst being used in reacting a lower olefin with a lower aliphatic carboxylic acid in a gas phase to produce a lower aliphatic carboxylic acid ester, wherein the process for producing the catalyst comprises the following first and second steps:

First Step

a step of loading one or more heteropolyacid on a support to obtain a heteropolyacid supported catalyst;

Second Step

a step of contacting the heteropolyacid supported catalyst obtained in the first step with a gas containing at least one member selected from the group consisting of water, a lower aliphatic carboxylic acid and a lower aliphatic alcohol to obtain a catalyst for use in producing a lower aliphatic carboxylic acid ester.

The present invention (III) is a process, for producing a lower aliphatic carboxylic acid ester, comprising reacting a lower olefin with a lower aliphatic carboxylic acid in a gas phase in the presence of the catalyst for use in producing a lower aliphatic carboxylic acid ester of the present invention (I).

The present invention (IV) is a process, for producing a lower aliphatic carboxylic acid ester, comprising reacting a lower olefin with a lower aliphatic carboxylic acid in a gas phase, wherein the production process comprises the following first to fourth steps:

First Step

a step of loading one or more heteropolyacid on a support to obtain a heteropolyacid supported catalyst;

Second Step

a step of filling the heteropolyacid supported catalyst obtained in the first step, into a reactor for use in the reaction of a lower olefin with a lower aliphatic carboxylic acid in a gas phase;

Third Step

a step of contacting a gas containing at least one member selected from the group consisting of water, a lower aliphatic carboxylic acid and a lower aliphatic alcohol, with the heteropolyacid supported catalyst filled in the reactor; and

Fourth Step

a step of passing a mixed gas containing a lower olefin and a lower aliphatic carboxylic acid through the heteropolyacid supported catalyst after the third step, to obtain a lower aliphatic carboxylic acid ester.

### BEST MODE FOR CARRYING OUT THE INVENTION

The present invention (I) is a catalyst, for use in producing a lower aliphatic carboxylic acid ester, which is used in reacting a lower olefin with a lower aliphatic carboxylic acid in a gas phase to produce a lower aliphatic carboxylic acid ester, wherein the process for producing the catalyst comprises the following first and second steps:

First Step

a step of loading one or more heteropolyacid on a support to obtain a heteropolyacid supported catalyst; and

Second Step

a step of contacting the heteropolyacid supported catalyst obtained in the first step with a gas containing at least one member selected from the group consisting of water, a lower aliphatic carboxylic acid and a lower aliphatic alcohol to obtain a catalyst for use in producing a lower aliphatic carboxylic acid ester.

That is, the catalyst, for use in producing a lower aliphatic carboxylic acid ester, of the present invention (I) is a catalyst obtained by a production process containing the above-described first and second steps in the production step.

The first step is described below. In the catalyst for use in producing a lower aliphatic carboxylic acid ester of the present invention (I), the heteropolyacid used in the first step comprises a center element and a peripheral element to which oxygen is bonded. The center element is usually silicon or phosphorus but may comprise an arbitrary element selected from various kinds of atoms belonging to Groups I to XVII of the Periodic Table.

Specific examples of the center element include cupric ion; divalent beryllium, zinc, cobalt and nickel ions; trivalent boron, aluminum, gallium, iron, cerium, arsenic, antimony, phosphorus, bismuth, chromium and rhodium ions; tetravalent silicon, germanium, tin, titanium, zirconium, vanadium, sulfur, tellurium, manganese, nickel, platinum, thorium, hafnium, cerium ions and other rare earth element ions; pentavalent phosphorus, arsenic, vanadium and antimony ions; a hexavalent tellurium ion; and a heptavalent iodide ion, however, the present invention is by no means limited thereto. Specific examples of the peripheral element include tungsten, molybdenum, vanadium, niobium and tantalum, however, the present invention is by no means limited thereto.

These heteropolyacids are also known as “polyoxo-anions”, “polyoxometallic salts” or “metal oxide clusters”. The structures of some well-known anions are named after researchers in this field, for example, Keggin, Wells-Dawson or Anderson-Evans-Perloff structures. These are described in detail in Poly-San no Kagaku, Kikan Kagaku Sosetsu (Chemistry of Polyacid, Quarterly of Chemistry General View), No. 20, edited by Nippon Kagaku Kai (1993). A heteropolyacid usually has a high molecular weight, for example, a molecular weight of 700 to 8,500, and includes not only monomers but also dimeric complexes thereof.

Specific examples of the heteropolyacid which can be used as the starting material of the heteropolyacid in the catalyst for use in producing a lower aliphatic carboxylic acid ester of the present invention (I) include:

| | |
|---|---|
| Tungstosilicic acid | H₄[SiW₁₂O₄₀].xH₂O |
| Tungstophosphoric acid | H₃[PW₁₂O₄₀].xH₂O |
| Molybdophosphoric acid | H₃[PMo₁₂O₄₀].xH₂O |
| Molybdosilicic acid | H₄[SiMo₁₂O₄₀].xH₂O |
| Vanadotungstosilicic acid | H₄₊ₙ[SiVₙW₁₂₋ₙO₄₀].xH₂O |
| Vanadotungstophosphoric acid | H₃₊ₙ[PVₙW₁₂₋ₙO₄₀].xH₂O |
| Vanadomolybdophosphoric acid | H₃₊ₙ[PVₙMo₁₂₋ₙO₄₀].xH₂O |
| Vanadomolybdosilicic acid | H₄₊ₙ[SiVₙMO₁₂₋O₄₀].xH₂O |
| Molybdotungstosilicic acid | H₄[SiMOₙW₁₂₋ₙO₄₀].xH₂O |
| Molybdotungstophosphoric acid | H₃[PMOₙW₁₂₋ₙO₄₀].xH₂O |

wherein n is an integer of 1 to 11 and x is an integer of 1 or more. However, the present invention is by no means limited thereto. Among these, preferred are tungstosilicic acid, tungstophosphoric acid, molybdophosphoric acid, molybdosilicic acid, vanadotungstosilicic acid and vanadotungstophosphoric acid, and more preferred are tungstosilicic acid, tungstophosphoric acid, vanadotungstosilicic acid and vanadotungstophosphoric acid.

The synthesis method for these heteropolyacids is not particularly limited and any method may be used. For example, the heteropolyacid may be obtained by heating an acidic aqueous solution containing a salt of molybdic acid or tungstic acid and a simple oxygen acid of hetero atom or a salt thereof (pH: about 1 to 2). For isolating the heteropolyacid compound from the aqueous heteropolyacid solution produced, a method of crystallizing and separating the compound in the form of a metal salt may be used. Specific examples thereof include those described in Shin Jikken Kagaku Koza 8, Muki Kagoubutsu no Gosei (III) (New Experimental Chemistry Course 8, Synthesis of Inorganic Compounds (III)), 3rd ed., page 1413, edited by Nippon Kagaku Kai, issued by Maruzen (Aug. 20, 1984), however, the present invention is not limited thereto. The Keggin structure of the heteropolyacid synthesized may be identified by chemical analysis or by X-ray diffraction or UV or IR measurement.

The heteropolyacid has a relatively high solubility in a polar solvent such as water and other oxygen-containing solvents, and the solubility can be controlled by appropriately selecting the counter ion.

In the catalyst for use in producing a lower aliphatic carboxylic acid ester of the present invention (I), the heteropolyacid as a catalytic activity component is loaded on a support. A substance which can be used as the support is not particularly limited and a porous substance commonly used as a support may be used. Specific examples thereof include those comprising silica, diatomaceous earth, montmorillonite, titania, activated carbon, alumina and silica alumina, preferably silica and titania.

The support is also not limited on the shape thereof and may be a powder or in a spherical, pellet-like or any other arbitrary shape. The shape is preferably a sphere or a pellet. Furthermore, the particle size is not particularly limited and in the case of a fixed bed reactor, the particle size is preferably from 2 to 10 mm, more preferably from 3 to 7 mm, and in the case of a fluidized bed reactor, the particle size is preferably from powder to 5 mm, more preferably from powder to 2 mm, though this varies depending on the reactor.

The support is most preferably a spherical or pellet-like siliceous support. The source or amount of the elements previously contained in the support can be measured by chemical analysis such as inductively coupled plasma emission spectrometry (hereinafter simply referred to as “ICP”), a fluorescent X-ray spectrometry or an atomic absorption spectrometry.

The method for loading a solution or suspension of heteropolyacid on a support in the first step of the catalyst, for producing a lower aliphatic carboxylic acid ester of the present invention (I), is not particularly limited and a known method may be used. Specifically, for example, the catalyst may be prepared by dissolving a heteropolyacid in a distilled water corresponding to the liquid absorption amount of the support used and impregnating the solution into a support. Also, the catalyst may be prepared using an excess aqueous solution by impregnating it into a support while appropriately moving the support in the heteropolyacid solution and then removing the excess acid by filtration. The volume of the solution or suspension used here varies depending on the support used or the loading method thereon.

The thus-obtained wet catalyst is suitably dried by placing it in a heating oven for a few hours. The drying method is not particularly limited and any method such as standing or a belt conveyor may be used. After the drying, the catalyst is preferably cooled to the ambient temperature in a desiccator so as not to absorb moisture.

The amount of the heteropolyacid supported in the heteropolyacid supported catalyst can be simply calculated by subtracting the weight of the support used from the weight after drying of the catalyst prepared. The supported amount may be more exactly determined by chemical analysis such as ICP, a fluorescent X-ray spectrometry or an atomic absorption spectrometry.

The amount of the heteropolyacid supported is preferably from 10 to 150% by mass, more preferably from 30 to 100% by mass, based on the entire weight of the support.

If the heteropolyacid content is less than 10% by mass, the amount of the active component content of the catalyst is too little and the activity per catalyst unit weight may disadvantageously decrease. If the heteropolyacid content exceeds 200% by mass, the effective pore volume decreases and, as a result, the effect owing to the increase in the supported amount may not be brought out and at the same time, coking is disadvantageously liable to occur to seriously shorten the catalyst life.

The second step is described below. The second step in the catalyst for use in producing a lower aliphatic carboxylic acid ester of the present invention (I) is a step of contacting the heteropolyacid supported catalyst obtained in the first step with a gas containing at least one member selected from the group consisting of water, a lower aliphatic carboxylic acid and a lower aliphatic alcohol.

The term “contact” as used herein means to contact the heteropolyacid supported catalyst obtained in the first step with a gas containing at least one member selected from the group consisting of water, a lower aliphatic carboxylic acid and a lower aliphatic alcohol. The method for the contact is not particularly limited and for example, the following methods may be used:

(a) a method of placing the heteropolyacid supported catalyst obtained in the first step in an atmosphere of a gas containing at least one member selected from the group consisting of water, a lower aliphatic carboxylic acid and a lower aliphatic alcohol;

(b) a method of passing a gas containing at least one member selected from the group consisting of water, a lower aliphatic carboxylic acid and a lower aliphatic alcohol through the heteropolyacid supported catalyst obtained in the first step; and

(c) a method of passing the heteropolyacid supported catalyst obtained in the first step, through an atmosphere of a gas containing at least one member selected from the group consisting of water, a lower aliphatic carboxylic acid and a lower aliphatic alcohol can be performed.

To speak more specifically on the method of performing the second step, for example, a method of filling the supported catalyst obtained in the first step into a vessel and contacting the gas therewith, or a method of filling the supported catalyst obtained in the first step into, in place of the vessel, a reactor where the production process of a lower aliphatic carboxylic acid ester is performed later, and contacting the gas therewith before feeding reaction starting materials, may be used.

With respect to the shape of the vessel or the reactor used, any shape such as vertical type or horizontal type may be used without any particular limit.

In view of the time to be spent for re-filling the catalyst or the vessel cost, the preferred embodiment of the second step includes a method of filling the supported catalyst obtained in the first step into a reactor which is used in reacting a lower olefin with a lower aliphatic carboxylic acid in a gas phase to produce a lower aliphatic carboxylic acid ester, and then contacting therewith a gas containing at least one member selected from the group consisting of water, a lower aliphatic carboxylic acid and a lower aliphatic alcohol before feeding the reaction starting materials. At this time, the reaction may be performed in either a closed circulatory system or a flow system.

The second step is preferably performed under the condition higher than the dew point of the gas containing at least one member selected from the group consisting of water, a lower aliphatic carboxylic acid and a lower aliphatic alcohol. If the condition is less than the dew point of the gas, a part of the gas may turn into a liquid. In this case, the heteropolyacid supported on the catalyst in the first step or other catalyst components supported if desired, may dissolve out to change the catalyst composition, and in the worst case, the catalyst may be deactivated. As long as the catalyst is not adversely affected, the conditions in performing the second step are not particularly limited.

The preferred embodiment of the condition higher than the dew point of the gas may vary depending on the composition of the gas or the pressure or the like in the practice of the step, however, the contact temperature is preferably from 80 to 300° C., more preferably from 100 to 260° C.

The contact pressure is not particularly limited and may be either normal pressure or pressure may be applied. The contact pressure is preferably from 0 MPaG (gauge pressure) to 3 MPaG (gauge pressure), more preferably from 0 MPaG (gauge pressure) to 2 MPaG (gauge pressure).

The lower aliphatic carboxylic acid in a gas containing at least one member selected from the group consisting of water, a lower aliphatic carboxylic acid and a lower aliphatic alcohol used in the second step, is preferably a lower aliphatic carboxylic acid having from 1 to 6 carbon atoms. Specific examples thereof include formic acid, acetic acid, propionic acid, n-butyric acid and isobutyric acid. Among these, preferred are acetic acid and propionic acid.

The lower aliphatic alcohol in a gas containing at least one member selected from the group consisting of water, a lower aliphatic carboxylic acid and a lower aliphatic alcohol used in the second step is preferably a lower aliphatic alcohol having from 1 to 6 carbon atoms. Specific examples thereof include methanol, ethanol, 1-propanol, 2-propanol, 1-butanol and 2-butanol. Among these, preferred are methanol, ethanol and n-propanol.

The composition of the gas containing at least one member selected from the group consisting of water, a lower aliphatic carboxylic acid and a lower aliphatic alcohol used in the second step is not particularly limited, and water, a lower aliphatic carboxylic acid and a lower aliphatic alcohol can be mixed in an arbitrary ratio. The composition is preferably such that water:lower aliphatic carboxylic acid:lower aliphatic alcohol=1.0:0.1 to 10.0:0.1 to 5.0 in terms of the molar ratio.

The composition of the gas may be constant from the beginning to the end of contacting or may be changed according to the contacting time or the stage of contacting.

The gas containing at least one member selected from the group consisting of water, a lower aliphatic carboxylic acid and a lower aliphatic alcohol used in the second step is more preferably water alone or a mixed gas of water and acetic acid, still more preferably a mixed gas of water and acetic acid because the effect can be provided within a short time.

In the case of using a mixed gas of water and acetic acid as the gas, the composition is not particularly limited but preferably is such that water:acetic acid=1.0:0.1 to 10.0, more preferably water:acetic acid=1.0:0.5 to 5.0, in terms of the molar ratio.

The gas hourly space velocity (hereinafter referred to as the “GHSV”) of the gas, which is the speed of feeding the gas in performing the contact with a gas containing at least one member selected from the group consisting of water, a lower aliphatic carboxylic acid and a lower aliphatic alcohol in the second step, is not particularly limited. The GHSV is preferably from 100 to 7,000 hr⁻¹, more preferably from 300 to 3,000 hr⁻¹.

If the GHSV is too high, the amount of the gas used increases and this is not preferred in view of the cost. From this standpoint, the contacting may also be performed by feeding a constant amount of the gas and enclosing it in a vessel.

The contacting time is not particularly limited, however, it is preferably from 0.5 to 200 hours, more preferably from 0.5 to 100 hours, and most preferably from 0.5 to 50 hours. The optimal time varies depending on the composition and concentration of the gas, the temperature and pressure at the contacting, and the catalyst component.

Generally, if the contacting time is less than 0.5 hours, the effect of the second step may not be fully brought out, whereas if the contacting time is prolonged, the effect is liable to increase but even if the contacting time is prolonged to exceed 200 hours, the effect does not increase any more, moreover, in the case where gas is contacted in a flowing state, the amount of the gas used increases and this is not preferred in view of the profitability.

In the catalyst, for use in producing a lower aliphatic carboxylic acid ester of the present invention (I), the first step and the second step may be performed either continuously or completely independently. More specifically, for example, a catalyst for use in producing a lower aliphatic carboxylic acid ester, which is obtained by purchasing a heteropolyacid catalyst passed through the first step and then subjecting it to the second step, is of course included in the scope of the catalyst for use in producing a lower aliphatic carboxylic acid ester of the present invention (I).

The present invention (II) is described below. The present invention (II) is a process for producing a catalyst for use in producing a lower aliphatic carboxylic acid ester, the catalyst being used in reacting a lower olefin with a lower aliphatic carboxylic acid in a gas phase to produce a lower aliphatic carboxylic acid ester, wherein the production process comprises the following first and second steps:

First Step

a step of loading one or more heteropolyacid on a support to obtain a heteropolyacid supported catalyst; and

Second Step

a step of contacting the heteropolyacid supported catalyst obtained at the first step with a gas containing at least one member selected from the group consisting of water, a lower aliphatic carboxylic acid and a lower aliphatic alcohol to obtain a catalyst for use in producing a lower aliphatic carboxylic acid ester.

The heteropolyacid and the support used in the first step, the method for loading the heteropolyacid on a support performed in the first step, the method for measuring the amount of heteropolyacid supported, and the preferred amount of heteropolyacid supported on a support are the same as in the present invention (I).

Furthermore, the method for contacting the catalyst with a gas containing at least one member selected from the group consisting of water, a lower aliphatic carboxylic acid and a lower aliphatic alcohol performed in the second step, the conditions therefor such as temperature, pressure, GHSV and time, the lower aliphatic carboxylic acid and lower aliphatic alcohol used for the gas, and the compositional ratio of the gas to which water is further added, are also the same as in the present invention (I).

In the process for producing a catalyst for use in producing a lower aliphatic carboxylic acid ester of the present invention (II), as long as the following first and second steps are contained, other steps may be provided before, after or during these steps, if desired.

First Step

A step of loading one or more heteropolyacid on a support to obtain a heteropolyacid supported catalyst.

Second Step

A step of contacting the heteropolyacid supported catalyst obtained in the first step with a gas containing at least one member selected from the group consisting of water, a lower aliphatic carboxylic acid and a lower aliphatic alcohol to obtain a catalyst for use in producing a lower aliphatic carboxylic acid ester.

Examples of the steps which are provided, if desired, include a step of loading a third component so as to more improve the catalytic activity. In such a case, this loading operation may be performed simultaneously with the operation of loading the heteropolyacid in the first step, if possible.

After the second step of contacting the catalyst with a gas containing at least one member selected from the group consisting of water, a lower aliphatic carboxylic acid and a lower aliphatic alcohol, the catalyst may further be contacted with another gas.

The present invention (III) is described below. The present invention (III) is a process for producing a lower aliphatic carboxylic acid ester, comprising reacting a lower olefin with a lower aliphatic carboxylic acid in a gas phase in the presence of the catalyst for use in producing a lower aliphatic carboxylic acid ester, of the present invention (I).

In practicing the process for producing a lower aliphatic carboxylic acid ester of the present invention (III), the gas phase reaction is not particularly limited in the reaction form and the reaction may be performed in any form such as fixed bed or a fluidized bed. The shape of the support which governs the shape or size of the catalyst may be selected in the range from powder to a compact formed into a size of several mm, according to the reaction form employed.

Examples of the lower olefin which can be used in the process for producing a lower aliphatic carboxylic acid ester of the present invention (III), include ethylene, propylene, n-butene, isobutene and a mixture of two or more thereof.

The lower aliphatic carboxylic acid is suitably an aliphatic carboxylic acid having from 1 to 4 carbon atoms and specific examples thereof include formic acid, acetic acid, propionic acid, butyric acid, acrylic acid, methacrylic acid, and a mixture of two or more thereof. Among these, preferred are acetic acid, propionic acid and acrylic acid, more preferred is acetic acid.

Specific examples of the combination of a lower olefin and a lower aliphatic carboxylic acid, which is preferably used in the process for producing a lower aliphatic carboxylic acid ester of (III), include ethylene and acetic acid, ethylene and propionic acid, propylene and acetic acid, and propylene and propionic acid. Among these, most preferred is the combination of ethylene and acetic acid.

The ratio between the lower olefin and the lower aliphatic carboxylic acid used as the starting materials is not particularly limited. In view of the conversion of the lower olefin, the lower olefin is preferably used in an equimolar or excess amount to the lower aliphatic carboxylic acid. To speak specifically, the molar ratio of the lower olefin to the lower aliphatic carboxylic acid is preferably in the range of lower olefin:lower aliphatic carboxylic acid=from 1:1 to 30:1, more preferably from 3:1 to 20:1, still more preferably from 5:1 to 15:1.

The addition of water to the starting materials is not particularly limited and water may or may not be added. From the standpoint of maintaining the catalytic activity, it is preferred to add a small amount of water. However, if an excessively large amount of water is added, the amount of by-products such as alcohol and ether disadvantageously increases.

In the process for producing a lower aliphatic carboxylic acid ester of the present invention (III), preferred reaction conditions, such as temperature and pressure, vary depending on the lower olefin and the lower aliphatic carboxylic acid used as the starting materials. The reaction conditions such as temperature and pressure are preferably combined so that the starting materials each can keep the gas state and the reaction can proceed satisfactorily.

In general, the temperature is preferably in the range from 120° C. to 300° C., more preferably from 140° C. to 250° C. The pressure is preferably in the range from atmospheric pressure to 3 MPaG (gauge pressure), more preferably from atmospheric pressure to 2 MPaG (gauge pressure).

The starting materials each is not particularly limited on the GHSV. If the GHSV is excessively high, the gas passes through before the reaction satisfactorily proceeds, whereas if it is too low, there may arise problems such as reduction in the productivity. The GHSV is preferably in the range from 100 hr⁻¹ to 7,000 hr⁻¹, more preferably from 300 hr⁻¹ to 3,000 hr⁻¹.

The unreacted lower olefin and also alcohol and ether produced as by-products in the reaction may be recycled and used as they are.

The present invention (IV) is described below. The present invention (IV) is a process for producing a lower aliphatic carboxylic acid ester, comprising reacting a lower olefin with a lower aliphatic carboxylic acid in a gas phase, wherein the production process comprises the following first to fourth steps:

First Step

a step of loading one or more heteropolyacid on a support to obtain a heteropolyacid supported catalyst;

Second Step

a step of filling the heteropolyacid supported catalyst obtained in the first step, into a reactor for use in the reaction of a lower olefin with a lower aliphatic carboxylic acid in a gas phase;

Third Step

a step of contacting a gas containing at least one member selected from the group consisting of water, a lower aliphatic carboxylic acid and a lower aliphatic alcohol, with the heteropolyacid supported catalyst filled in the reactor; and

Fourth Step

a step of passing a mixed gas containing a lower olefin and a lower aliphatic carboxylic acid through the heteropolyacid supported catalyst after the third step, to obtain a lower aliphatic carboxylic acid ester.

The first step is described below. The first step in the process for producing a lower aliphatic carboxylic acid ester of the present invention (IV) is a step of loading one or more heteropolyacid on a support to obtain a heteropolyacid supported catalyst.

The heteropolyacid and the support used in the first step, the method for loading the heteropolyacid on a support performed in the first step, the method for measuring the amount of heteropolyacid supported, and the preferred amount of heteropolyacid supported on a support are the same as in the present invention (I).

The second step is described below. The second step in the process for producing a lower aliphatic carboxylic acid ester of the present invention (IV) is a step of filling the heteropolyacid supported catalyst obtained in the first step, into a reactor for use in reacting a lower olefin with a lower aliphatic carboxylic acid in a gas phase.

The second step is a step of filling the heteropolyacid supported catalyst into a reactor for use in the reaction of a lower olefin with a lower aliphatic carboxylic acid, so that the second step of the present invention (I), which is the catalyst for use in producing a lower aliphatic carboxylic acid ester, or the second step of the present invention (II) which is the process for producing a catalyst for use in producing a lower aliphatic carboxylic acid ester, namely, the step of contacting the heteropolyacid supported catalyst obtained in the first step with a gas containing at least one member selected from the group consisting of water, a lower aliphatic carboxylic acid and a lower aliphatic alcohol, can be performed in that reactor without using another vessel.

The reactor used in the second step is not particularly limited. A fixed bed gas phase contact-type reactor is preferred, and a reactor having a form of multi-tube system and/or multi-layer system is more preferred. In general, a reactor having a form of multi-tube system and/or multi-layer system is superior in the reaction results, thermal efficiency, ease of control and the like. Of course, the present invention is not limited thereto.

In the present invention, the term “filling the catalyst into a reactor” means to place the catalyst in a predetermined site of the reactor. The site and the method for the placement and, in the case where the reactor uses a fixed bed system, the method for fixing the catalyst vary depending on the form of the reactor and these are not particularly limited. Specific examples of the reactor include FIG. C•4•43 “Methanol Contacting Gaseous Phase Reactor” in the item of “4) Fixed catalyst gas phase reactor”, described in Kagaku Sochi Binran (Chemical Apparatuses Handbook), 2nd ed., 3rd imp., pp. 905 to 906, edited by Kagaku Kogyo Kyokai, published by Maruzen (Feb. 20, 1980).

The third step is described below. The third step in the process for producing a lower aliphatic carboxylic acid ester of the present invention (IV) is a step of contacting a gas containing at least one member selected from the group consisting of water, a lower aliphatic carboxylic acid and a lower aliphatic alcohol, with the heteropolyacid supported catalyst filled in the reactor.

The method for contacting the catalyst with a gas containing at least one member selected from the group consisting of water, a lower aliphatic carboxylic acid and a lower aliphatic alcohol performed in the third step, the conditions such as temperature, pressure, GHSV and time, the lower aliphatic carboxylic acid and lower aliphatic alcohol used for the gas, and the compositional ratio of the gas to which water is further added, are the same as in the second step of the present invention (I).

In performing the contacting in the reactor, the conditions therefor are not particularly limited, and the preferred conditions are considered to vary depending on the form, shape, size or constructive material of the reactor used for the contacting. In general, the contacting may be performed in the conditions described above for the second step of the present invention (I).

The fourth step is described below. The fourth step of the present invention (IV) is a step of passing a mixed gas containing a lower olefin and a lower aliphatic carboxylic acid through the heteropolyacid supported catalyst after the third step, to obtain a lower aliphatic carboxylic acid ester.

With respect to the specific examples, the preferred combinations and ratio in the amounts of the lower olefin and the lower aliphatic carboxylic acid used in the fourth step, the conditions in the practice of the fourth step, such as addition of water, temperature, pressure and GHSV, and the recycling operation mainly of unreacted lower olefin, those in the process for the producing a lower aliphatic carboxylic acid ester of the present invention (III) can be applied.

The third step and the fourth step of the present invention (IV) may or may not be clearly distinguished. Examples of the practical embodiment having a clear distinction between those two steps include the case where after judging that the contacting in the third step is finished, the flow of the gas containing at least one member selected from the group consisting of water, a lower aliphatic carboxylic acid and a lower aliphatic alcohol is once stopped or the temperature is further lowered to terminate the third step and, thereafter, the starting material gas containing a lower olefin and a lower aliphatic carboxylic acid is passed as the reaction gas in the fourth step.

Examples of practical embodiments not having a clear distinction between those two steps include the case where, after judging that the contacting in the third step is finished, while not once stopping the flow of the gas containing at least one member selected from the group consisting of water, a lower aliphatic carboxylic acid and a lower aliphatic alcohol or by adjusting the temperature to the range suitable for the fourth step to prepare the initiation of reaction, the starting material gas containing a lower olefin and a lower aliphatic carboxylic acid is passed as the reaction gas in the fourth step.

For example, in the case where the lower aliphatic carboxylic acid used for the contacting in the third step is a lower aliphatic carboxylic acid corresponding to the objective ester in the process for producing a lower aliphatic carboxylic acid ester of the present invention (IV), the reaction may be performed according to a practical embodiment not having a clear distinction between the third step and the fourth step. On the other hand, in the case where the lower aliphatic carboxylic acid used for the contacting in the third step is not a lower aliphatic carboxylic acid corresponding to the objective ester, the reaction is preferably performed by providing a clear distinction between those two steps.

In general, the contacting in the third step is preferably performed using a lower aliphatic carboxylic acid corresponding to the objective ester in the process for producing a lower aliphatic carboxylic acid ester of the present invention (IV). For example, in the case of producing ethyl acetate as the lower aliphatic carboxylic acid ester by applying the process for producing a lower aliphatic carboxylic acid ester of the present invention (IV), one of the preferred practical embodiments is a method of performing the contacting in the third step using a mixed gas of water and acetic acid for a constant time under constant conditions, then changing various conditions within the reactor, such as temperature, pressure and GHSV, to suit the production process of a lower aliphatic carboxylic acid ester, and subsequently adding ethylene to the gas which is introduced into the reactor. Of course, the present invention (IV) is not limited thereto.

The present invention is described in greater detail below by referring to the Examples and Comparative Examples, however, the present invention should not be construed as being limited thereto.

Conditions for Analysis of Metals in Support

The analysis of metals in the support was performed using a fluorescent X-ray analyzer (PW2404, manufactured by PHILIPS). Measurement conditions were such that the atmosphere was helium, the effective diameter was 25.0 mm, and the matrix was 2SiO₂.

Conditions for Analysis of Uncondensed Gas

An absolute calibration curve method was used for the analysis. The analysis was performed under the following conditions by sampling 50 ml of the effluent gas and passing the whole amount thereof into a 1 ml-volume gas sampler attached to the gas chromatograph.

1. Ether, Carboxylic Acid Ester, Alcohol and Trace By-Products

Gas chromatography: gas chromatography (GC-14B, manufactured by Shimadzu Seisakusho Co.) with a gas sampler for Shimadzu gas chromatograph (MGS-4, measuring tube: 1 ml)

Column: packed column SPAN 80, 15% Shinchrom A of 60 to 80 mesh (length: 5 m)

Carrier gas: nitrogen (flow rate: 25 ml/min)

Temperature conditions: The detector and the vaporization chamber were at a temperature of 120° C., and the column temperature was 65° C. and constant.

Detector: FID (H₂ pressure: 60 kPa, air pressure: 100 kPa)

2. Butene

Gas chromatography: gas chromatography (GC-14B, manufactured by Shimadzu Seisakusho Co.) with a gas sampler for Shimadzu gas chromatograph (MGS-4, measuring tube: 1 ml)

Column: packed column Unicarbon A-400 of 80/100 mesh, length: 2 m

Carrier gas: helium (flow rate: 23 ml/min)

Temperature conditions: The detector and the vaporization chamber were at a temperature of 130° C., and the column temperature was elevated from 40° C. to 95° C. at a temperature increasing rate of 40° C./min.

Detector: FID (H₂ pressure: 70 kPa, air pressure: 100 kPa)

3. Ethylene

Gas chromatography: gas chromatography (GC-14B, manufactured by Shimadzu Seisakusho Co.) with a gas sampler for Shimadzu gas chromatograph (MGS-4, measuring tube: 1 ml)

Column: packed column Unibeads IS, length: 3 m

Carrier gas: helium (flow rate: 20 ml/min)

Temperature conditions: The detector and the vaporization chamber were at a temperature of 120° C., and the column temperature was 65° C. and constant.

Detector: TCD (He pressure: 70 kPa, current: 90 mA, temperature: 120° C.)

Analysis of Solution Collected

The analysis was performed using the internal standard method, where the analysis solution was prepared by adding 1 ml of 1,4-dioxane as the internal standard to 10 ml of the reaction solution and 0.4 μl of the analysis solution was injected.

Gas chromatography: gas chromatography (GC-14B manufactured by Shimadzu Seisakusho Co.)

Column: capillary column TC-WAX (length: 30 m, inner diameter: 0.25 mm, film thickness: 0.25 μm)

Carrier gas: nitrogen (split ratio: 20, column flow rate: 1 ml/min)

Temperature conditions: The detector and the vaporization chamber were at a temperature of 200° C., and the column temperature was kept at 40° C. for 7 minutes from the start of analysis, then elevated to 230° C. at a temperature increasing rate of 10° C./min, and kept at 230° C. for 5 minutes.

Detector: FID (H₂ pressure: 70 kPa, air pressure: 100 kPa)

<Support>

Support 1: synthetic silica (N-602T, produced by Nikki Kagaku K. K.) (specific surface area: 132 m²/g, pore volume: 0.7 cm³/g)

Support 2: synthetic silica (CARiACT Q-10, produced by Fuji Silicia Kagaku K. K.) (specific surface area: 219.8 m²/g, pore volume: 0.660 cm³/g)

Support 3: silica gel (Wakogel C-200, produced by Wako Junyaku Kogyo K. K.) (specific surface area: 762 m²/g, pore volume: 0.23 cm³/g)

The metal analysis results of each support are shown in Table 1.

TABLE 1

| | | SiO₂ | K₂O | Na₂O |
|---|---|---|---|---|
| 1 | N-602T | 99.7 | 0.0085 | 0.3190 |
| 2 | CARiACT Q-10 | 100.0 | — | 0.0214 |
| 3 | C-200 | 100.0 | — | — |
| Unit (%) | | | | |

<Preparation Process of Catalyst 1>

Support 1 was preliminarily dried for 4 hours in a (hot-air type) drier previously adjusted to 110° C. After the preliminary drying, 1 liter of the support was measured on the bulk density using a 1 liter measuring cylinder. Tungstosilicic acid was weighed to the amount shown in Table 1 and after adding thereto 15 ml of pure water, uniformly dissolved. To this impregnating solution, pure water was further added to make the liquid amount shown in Volume of Solution Prepared of Table 1. Thereafter, the preliminarily dried support was weighed to the amount shown in Table 2, added to the impregnating solution and impregnated with the solution while thoroughly stirring. The support impregnated with the solution was transferred to a porcelain dish, air-dried for 1 hour and then dried in a hot-air type drier adjusted to 150° C. for 5 hours. After the drying, the catalyst was transferred to a desiccator and left standing to cool to room temperature. The weight of the thus-obtained catalyst was measured.

TABLE 2

| | | | | | | Volume | |
|---|---|---|---|---|---|---|---|
| | | | Weight | | Amount of | of | Weight |
| | | Bulk | of | Kind of | Catalyst | Solution | after |
| Catalyst | | Density | Support | Catalyst | Component | Prepared | Drying |
| Name | Support | (g/L) | (g) | Component | (g) | (ml) | (g) |
| Catalyst 1 | support 1 | 813 | 81.3 | HSiW | 46.51 | 69 | 112.2 |
| Catalyst 2 | support 1 | 813 | 81.3 | HSiW | 40.70 | 69 | 116.8 |
| Catalyst 3 | support 2 | 456 | 45.6 | HSiW | 40.70 | 43 | 76.1 |
| Catalyst 4 | support 1 | 813 | 81.3 | HPW | 47.51 | 69 | 116.8 |
| Catalyst 5 | support 1 | 813 | 81.3 | HPW | 53.44 | 69 | 121.9 |
| Catalyst 6 | support 2 | 456 | 45.6 | HPVW | 35.90 | 43 | 76.3 |
| Catalyst 7 | support 3 | 1045 | 104.5 | HSiW | 34.88 | 31 | 134.7 |

HPW: H₃PW₁₂O₄₀
HSiW: H₄SiW₁₂O₄₀
HPVW: H₄PVW₁₁O₄₀

<Preparation Process of Catalysts 2 to 7>

These catalysts were prepared by changing the kind and weight of the support, and the kind and weight of the catalyst component as shown in Table 2 in Preparation Process of Catalyst 1.

### EXAMPLE 1

Into a pressure-resistant vessel made of SUS316L, 50 ml of the catalyst obtained in Preparation Process of Catalyst 1 was filled and then contacted under the contacting conditions shown in Table 3. After the contacting, the vessel was returned to room temperature and the catalyst used for the contacting (hereinafter simply referred to as a “contacted catalyst”) was taken out from the vessel. Subsequently, 40 ml of the contacted catalyst was filled into a reaction tube and a mixed gas of ethylene:acetic acid:steam:nitrogen (=78.5:8.0:4.5:9.0 by volume) was introduced thereinto at a temperature of 165° C., a pressure of 0.8 MPaG (gauge pressure) and a GHSV of 1,500 hr⁻¹, and reacted. The gas passed through the catalyst layer was collected under ice cooling for a predetermined time and the entire amount was recovered and analyzed (hereinafter simply referred to as a “condensed solution”). The outlet gas remaining uncondensed (hereinafter simply referred to as an “uncondensed gas”) was measured on the gas flow rate for the same predetermined time as in the condensed solution and then 50 ml of the gas was sampled and analyzed. The results are shown in Table 3.

TABLE 3

| | | Pretreatment Conditions | | | | | | | | |
|---|---|---|---|---|---|---|---|---|---|---|
| | | Composition of | | | | | Reaction Results | | | |
| | | Gas Treated, | Gas | | | | | Ethyl | Amount of | Trace |
| | | acetic acid: | Flow | | Treating | Treating | Reaction | Acetate, | Butene | By- |
| | | water: nitrogen | Rate | Pressure | Temperature | Time | Time | STY | Produced | Products |
| | Catalyst | (by mol) | (NL/hr) | (MPaG) | (° C.) | (hr) | (hr) | (g/L-hr) | (vol ppm) | (wt %) |
| Example 1 | Catalyst 1 | 6.0:6.0:88.0 | 60.0 | 0.8 | 165 | 12 | 5 | 245 | 313 | 0.0119 |
| | | | | | | | 50 | 234 | 399 | 0.0138 |
| Example 2 | Catalyst 1 | 0.0:12.5:87.5 | 60.0 | 0.8 | 165 | 12 | 5 | 243 | 424 | 0.0123 |
| | | | | | | | 50 | 231 | 521 | 0.0140 |
| Example 3 | Catalyst 2 | 6.0:6.0:88.0 | 60.0 | 0.8 | 165 | 12 | 5 | 265 | 419 | 0.0132 |
| | | | | | | | 50 | 251 | 515 | 0.0154 |
| Example 6 | Catalyst 3 | 6.0:6.0:88.0 | 60.0 | 0.8 | 165 | 12 | 5 | 254 | 245 | 0.0089 |
| | | | | | | | 50 | 243 | 342 | 0.0111 |
| Example 7 | Catalyst 4 | 6.0:6.0:88.0 | 60.0 | 0.8 | 165 | 12 | 5 | 255 | 480 | 0.0243 |
| | | | | | | | 50 | 242 | 578 | 0.0340 |
| Example 8 | Catalyst 4 | 0.0:12.5:87.5 | 60.0 | 0.8 | 165 | 12 | 5 | 253 | 491 | 0.0251 |
| | | | | | | | 50 | 241 | 582 | 0.0374 |
| Example 9 | Catalyst 5 | 6.0:6.0:88.0 | 60.0 | 0.8 | 165 | 12 | 5 | 267 | 524 | 0.0359 |
| | | | | | | | 50 | 253 | 589 | 0.0462 |
| Example 10 | Catalyst 6 | 6.0:6.0:88.0 | 60.0 | 0.8 | 165 | 12 | 5 | 140 | 150 | 0.0050 |
| | | | | | | | 50 | 136 | 192 | 0.0075 |
| Example 11 | Catalyst 7 | 6.0:6.0:88.0 | 60.0 | 0.8 | 165 | 12 | 5 | 235 | 319 | 0.0098 |
| | | | | | | | 50 | 228 | 342 | 0.0113 |

### EXAMPLES 2 TO 11

In the same manner as in Example 1, 50 ml of the catalyst obtained in Preparation Process of Catalyst 1 was filled into a pressure-resistant vessel made of SUS316L and contacted under the contacting conditions shown in Table 3. Thereafter, the catalyst was taken out, filled into a reaction tube and then subjected to a reaction in the same manner as in Example 1. The results are shown in Table 3.

### COMPARATIVE EXAMPLE 1

Into a reaction tube, 40 ml of the same catalyst as in Example 1 was filled and then a mixed gas of ethylene:acetic acid:steam:nitrogen (=78.5:8.0:4.5:9.0 by volume) was introduced thereinto at a temperature of 165° C., a pressure of 0.8 MPaG (gauge pressure) and a GHSV of 1,500, and reacted. The gas passed through the catalyst layer was collected and analyzed in the same manner as in Example 1. The results are shown in Table 4.

TABLE 4

| | | Pretreatment Conditions | | | | | Reaction Results | | | |
|---|---|---|---|---|---|---|---|---|---|---|
| | | Composition of | | | | | | | Amount | |
| | | Gas Treated, | | | | | | Ethyl | of | Trace |
| | | acetic acid: | Gas Flow | | Treating | Treating | Reaction | Acetate, | Butene | By- |
| | | water: nitrogen | Rate | Pressure | Temperature | Time | Time | STY (g/L- | Produced | Products |
| | Catalyst | (by mol) | (NL/hr) | (MPaG) | (° C.) | (hr) | (hr) | hr) | (vol ppm) | (wt %) |
| Comparative | catalyst 1 | none | — | — | — | — | 5 | 230 | 420 | 0.0219 |
| Example 1 | | | | | | | 50 | 214 | 443 | 0.0253 |
| Comparative | catalyst 2 | none | — | — | — | — | 5 | 247 | 453 | 0.0255 |
| Example 2 | | | | | | | 50 | 228 | 589 | 0.0348 |
| Comparative | catalyst 3 | none | — | — | — | — | 5 | 245 | 308 | 0.0123 |
| Example 3 | | | | | | | 50 | 216 | 328 | 0.0145 |
| Comparative | catalyst 4 | none | — | — | — | — | 5 | 245 | 521 | 0.0352 |
| Example 4 | | | | | | | 50 | 226 | 604 | 0.0492 |
| Comparative | catalyst 5 | none | — | — | — | — | 5 | 255 | 480 | 0.0234 |
| Example 5 | | | | | | | 50 | 236 | 578 | 0.0329 |
| Comparative | catalyst 6 | none | — | — | — | — | 5 | 135 | 200 | 0.0129 |
| Example 6 | | | | | | | 50 | 124 | 243 | 0.0246 |
| Comparative | catalyst 7 | none | — | — | — | — | 5 | 225 | 424 | 0.0234 |
| Example 7 | | | | | | | 50 | 208 | 534 | 0.0358 |

### COMPARATIVE EXAMPLES 2 TO 7

40 ml of the catalyst shown in Table 2 was filled into a reaction tube in the same manner as in Comparative Example 1 and a reaction was performed in the same manner as in Comparative Example 1. The reaction results are shown in Table 4.

Industrial Applicability

It is apparent from the results in the foregoing pages that by containing specific steps in the preparation of heteropolyacid catalyst, the reduction in activity can be suppressed and when used as a catalyst in producing a lower aliphatic carboxylic acid ester from a lower olefin and a lower aliphatic carboxylic acid, the catalyst can exhibit high initial activity and high space time yield, to ensure a sufficiently long catalyst life in industrial practice, and can reduce the production of by-products.

1. A process for producing a catalyst for use in producing a lower aliphatic carboxylic acid ester, said catalyst being used in reacting a lower olefin with a lower aliphatic carboxylic acid in a gas phase to produce a lower aliphatic carboxylic acid ester, which process comprises the following first and second steps:
First Step
a step of loading one or more heteropolyacid on a support to obtain a heteropolyacid supported catalyst; and
Second Step
a step of contacting the heteropolyacid supported catalyst obtained in the first step with a gas containing at least one member selected from the group consisting of water, a lower aliphatic carboxylic acid and a lower aliphatic alcohol to obtain a catalyst for use in producing a lower aliphatic carboxylic acid ester.

2. A process as claimed in claim 1, wherein the second step is performed in the reactor for use in the reaction of a lower olefin with a lower aliphatic carboxylic acid in a gas phase.

3. A process as claimed in claim 1 or 2, wherein the heteropolyacid is selected from the group consisting of tungstosilicic acid, tungstophosphoric acid, molybdophosphoric acid, molybdosilicic acid, vanadotungstosilicic acid, vanadotungstophosphoric acid, vanadomolybdophosphoric acid, vanadomolybdosilicic acid, molybdotungstosilicic acid and molybdotungstophosphoric acid.

4. A process as claimed in claim 1 or 2, wherein the second step is performed at a temperature of 80 to 300° C.

5. A process as claimed in claim 1 or 2, wherein the second step is performed under a pressure of 0 MPaG (gauge pressure) to 3 MPaG (gauge pressure).

6. A process as claimed in claim 1 or 2, wherein the second step is performed at a gas hourly space velocity (GHSV) of 100 to 7,000 hr⁻¹.

7. A process as claimed in claim 1 or 2, wherein the gas containing at least one member selected from the group consisting of water, a lower aliphatic carboxylic acid and a lower aliphatic alcohol used in the second step is a mixed gas of water and acetic acid.
